(19) United States
(12) Patent Application Publication
(10) Pub. No.: US 2024/0295749 A1
(43) Pub. Date: Sep. 5, 2024

(54) AERIAL DISPLAY DEVICE

(71) Applicant: MINEBEA MITSUMI Inc., Nagano (JP)

(72) Inventors: Taku YAMADA, Kitasaku-gun (JP); Tomoko OHARA, Kitasaku-gun (JP); Shohei HAMADA, Kitasaku-gun (JP); Hirotsugu YAMAMOTO, Utsunomiya-shi (JP)

(21) Appl. No.: 18/549,651

(22) PCT Filed: Dec. 10, 2021
(86) PCT No.: PCT/JP2021/045703

§ 371 Date: Sep. 8, 2023

(30) Foreign Application Priority Data
Mar. 12, 2021 (JP) 2021-039965
Oct. 28, 2021 (JP) 2021-176729

(51) Int. Cl. G02B 30/56; G02B 30/25; G06F 3/044

(52) U.S. Cl. CPC G02B 30/56; G02B 6/0038; G02B 6/0055; G02B 6/0056; G02B 30/25; G06F 3/0443; G06F 2203/04108

(57) ABSTRACT

An aerial display device of an embodiment includes a planar light-emitting body, a retroreflective sheet, and a half mirror. The planar light-emitting body includes a light-emitting portion. The retroreflective sheet is disposed at an emission surface side of the planar light-emitting body, and includes, at a position corresponding to the light-emitting portion, a plurality of through-holes representing a figure to be displayed in the air. The half mirror is disposed at an emission surface side of the retroreflective sheet.

### TECHNICAL FIELD

The present invention relates to an aerial display device.

### BACKGROUND ART

An aerial display device allowing an image to be formed in the air by using a retroreflective sheet or a half mirror has been proposed (for example, refer to Patent Documents 1 and 2).

### CITATION LIST

### Patent Literature

Patent Document 1: JP 2018-81138 A
Patent Document 2: JP 2017-107165 A

### SUMMARY OF INVENTION

### Technical Problem

However, the conventional techniques are mainly intended to facilitate adjustment of a position with an image being formed and to enable observation of an image displayed in the air from a wide angle, and are not intended to improve the quality of aerial display.

The present invention has been made in view of the above, and an object of the present invention is to provide an aerial display device allowing improvement in the quality of aerial display.

### Solution to Problem

To solve the above-described problems and achieve the object, an aerial display device according to one aspect of the present invention includes a planar light-emitting body, a retroreflective sheet, and a half mirror. The planar light-emitting body includes a light-emitting portion. The retroreflective sheet is disposed at an emission surface side of the planar light-emitting body and includes, at a position corresponding to the light-emitting portion, a plurality of through-holes representing a figure to be displayed in the air. The half mirror is disposed at an emission surface side of the retroreflective sheet.

The aerial display device according to one aspect of the present invention allows improvement in the quality of aerial display.

### BRIEF DESCRIPTION OF DRAWINGS

FIG. 1 is a view illustrating an example of an aerial display device according to an embodiment as viewed from a display surface side.

FIG. 2 is a cross-sectional view taken along line X-X in FIG. 1.

FIG. 3 is a view illustrating a placement example of an operation panel in a toilet cubicle.

FIG. 4 is a view illustrating an example of an aerial display device as a comparative example, as viewed from the display surface side.

FIG. 5 is a cross-sectional view taken along line X-X in FIG. 4.

FIG. 6 is a view of a part of an optical element provided in a light guide plate as viewed from a normal direction of a back surface of the light guide plate.

FIG. 7 is a cross-sectional view taken along line Y-Y in FIG. 6.

FIG. 8 is a view illustrating an example. In the example, a light-emitting portion of the light guide plate is in a state of being invisible by light distribution control of the light-emitting portion.

FIG. 9 is a view illustrating an example of a shape of the optical element constituting the light-emitting portion of the light guide plate.

FIG. 10 is a view showing a value defining a recessed optical element (FIG. 9) having a V-shaped cross-section as an example of the optical element.

FIG. 11 is a view illustrating an example. In the example, the light-emitting portion is in a state of being invisible by a light blocking sheet provided with through-holes.

FIG. 12 is a view illustrating an example. In the example, the light-emitting portion is in a state of being invisible by a louver sheet.

FIG. 13 is a view illustrating an example. In the example, a light-emitting portion 4b is in a state of being invisible by a polarizing reflection sheet, a retardation film, and the polarizing reflection sheet.

FIG. 14 is a cross-sectional view of an aerial display device illustrating a first improved example of the configuration of FIG. 13.

FIG. 15 is a cross-sectional view of an aerial display device illustrating a second improved example of the configuration of FIG. 13.

FIG. 16 is a cross-sectional view of an aerial display device illustrating a third improved example of the configuration of FIG. 13.

FIG. 17 is a cross-sectional view of an aerial display device illustrating a fourth improved example of the configuration of FIG. 13.

FIG. 18 is a cross-sectional view of an aerial display device illustrating a fifth improved example of the configuration of FIG. 13.

FIG. 19 is a view illustrating an example of a luminance distribution around the aerial display.

FIG. 20 is a cross-sectional view illustrating an example of a structure of a retroreflective sheet.

FIG. 21 is a view illustrating an example of detection of a touch on the aerial display by an electrostatic sensor including sensor electrodes.

### DESCRIPTION OF EMBODIMENTS

Hereinafter, an aerial display device according to an embodiment will be described with reference to the drawings. Note that the present invention is not limited to the embodiment. Furthermore, the dimensional relationships between elements, proportions of the elements, and the like in the drawings may differ from reality. The drawings may each include parts having mutually different dimensional relationships and proportions. Furthermore, the contents described in one embodiment or modification examples are applied in principle to other embodiments or modification examples.

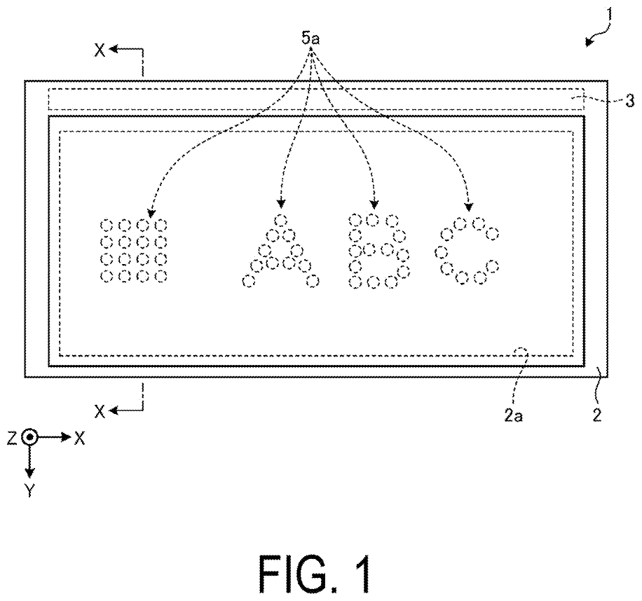

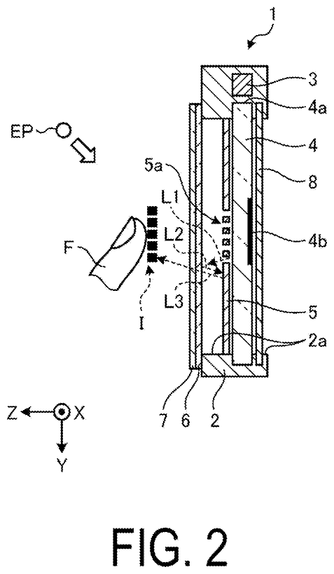

FIG. 1 is a view illustrating an example of an aerial display device 1 according to an embodiment as viewed from a display surface side. FIG. 2 is a cross-sectional view taken along line X-X in FIG. 1. Note that the aerial display device 1 in FIGS. 1 and 2 is assumed to be employed in an operation panel installed on a wall surface or the like in a private toilet, and a display surface is oriented in a horizontal direction.

In FIGS. 1 and 2, in the aerial display device 1, a linear light source 3 and a light guide plate 4 constituting a planar light-emitting body are disposed in a frame 2, and a substantially rectangular opening 2a is formed in the frame 2. The linear light source 3 emits light linearly along the longitudinal direction (X-axis direction) of a light incident side surface 4a of the light guide plate 4. The light guide plate 4 is formed of a transparent material such as polycarbonate or acrylic, guides light incident from the light incident side surface 4a to the terminal end side, and reflects the light by a light-emitting portion 4b formed of an optical element provided at the back surface (non-display surface) side.

In the present embodiment, light is emitted in a direction such that an eye point EP at the display surface side is not present in the direction (the lower left side in FIG. 2) and light emitted in a predetermined direction such that the eye point EP is present in the direction is suppressed by adjusting the optical element of the light-emitting portion 4b. The eye point EP is a position: the user is assumed to perform viewing at the position.

Further, the light-emitting portion 4b of the light guide plate 4 emits light in a substantially rectangular region (a shape viewed from the display surface side) that covers, with a margin, positions of a plurality of through-holes 5a (also covers a predetermined range around the through-holes 5a) likely to be used to represent a figure to be displayed in the air in the retroreflective sheet 5 described below, or emits light in a region that covers, with a margin, a position corresponding to one or a plurality of the through-holes 5a of the retroreflective sheet 5 (also covers a predetermined range around the through-holes 5a). In the former case, an end portion of the light-emitting portion 4b of the light guide plate 4 is set long in the light guide direction (Y-axis direction) from the position directly facing the outermost through-hole 5a of the retroreflective sheet 5. In consideration of light distribution, positional accuracy of members, and the like, the end portion set long is located outside a position where the optical axis is extended in the opposite direction from the through-holes 5a of the retroreflective sheet 5 to reach the vicinity of the back side of the light guide plate 4. In the lateral direction (X-axis direction), the light-emitting portion 4b of the light guide plate 4 extends over substantially the entire width of the light guide plate 4. In the latter case, the light-emitting portion 4b of the light guide plate 4 is set long in the light guide direction (Y-axis direction) and the lateral direction (X-axis direction) for each through-hole 5a of the retroreflective sheet 5. In the former case, when the figure to be displayed in the air is changed, it is only necessary to change the through-holes 5a of the retroreflective sheet 5, whereby the change is facilitated. Further, in the latter case, since the light emitted from the light guide plate 4 can be narrowed down to the light necessary for display, the light efficiency can be enhanced.

Further, at the non-display surface side of the frame 2, a reflection sheet 8 is disposed covering the opening 2a, and light leaking from the light guide plate 4 to the rear surface side is returned to the light guide plate 4, thereby increasing light efficiency and luminance. Note that the opening 2a need not be provided at the non-display surface side of the frame 2 (may be closed by a bottom plate), and the reflection sheet 8 is provided at the non-display surface side of the light guide plate 4.

At the emission surface side of the light guide plate 4, the retroreflective sheet 5 including the plurality of through-holes 5a representing the figure to be displayed in the air at a position corresponding to the light-emitting portion 4b is disposed with the reflective surface facing the emission surface side (the side opposite to the light guide plate 4). The through-holes 5a provided in the retroreflective sheet 5 are dot-like small round holes in the illustrated example, but may be holes having any shape constituting a pictogram, for example. The same applies to the through-holes 5a in the following embodiments. The retroreflective sheet 5 is a sheet with transparent minute glass beads or the like being disposed at the surface without gaps, and the sheet has a property of emitting incident light through the same path (the incident angle and the emission angle are the same). For the retroreflective sheet 5, other than the glass beads, a so-called corner cube may be used, and in the corner cube, three surfaces having a property of reflecting light are combined with each other at right angles and inner surfaces of apexes of a cube are used. In this case, the cost is slightly increased, but there is an advantage that the light use efficiency is high and blurring of the aerial display (aerial image) is reduced.

In addition, a half mirror 6 is disposed at the display surface side of the frame 2, covering the opening 2a, and a top cover 7 is superimposed on the outside of the half mirror 6. Although the top cover 7 can be omitted by applying a hard coat treatment to the outer side (viewing side) of the half mirror 6, a transparent resin plate for support is required because the half mirror 6 is film-like. It should be noted that the hard coat treatment is performed for the purpose of scratch prevention, stain prevention, antibacterial treatment, and the like, and even when the top cover 7 is disposed at the outer side, it is preferable to perform the hard coat treatment on the top cover 7. The half mirror 6 is an optical member having a property of reflecting about a half of incident light and transmitting about the other half of the incident light. The top cover 7 is formed of a transparent material to protect the half mirror 6. By reducing the transmittance of the top cover 7, the inside of the aerial display device 1 is less likely to be visible from the outside, and only the aerial display can be easily visible. The retroreflective sheet 5 and the half mirror 6 may be disposed slightly inclined with respect to each other.

In FIG. 2, the light emitted from the light-emitting portion 4b of the light guide plate 4 included in the planar light-emitting body passes through the through-holes 5a of the retroreflective sheet 5 and is emitted along a path L1. About half of the light is reflected by the half mirror 6 and impinges on the retroreflective sheet 5 through a path L2. The light having impinged on the retroreflective sheet 5 returns to the half mirror 6 along a path L3 at the emission angle being the same as the incident angle, and about a half of the light is transmitted. Since the light emitted from a certain point of the light-emitting portion 4b passes through the same position outside the aerial display device 1 due to the geometric relationship even when the angle of the path L1 changes, aerial display I by the aerial image is performed outside the half mirror 6 and the top cover 7, and can be visually recognized from the eye point EP of the user, and the user can perform the operation of touching with a finger F.

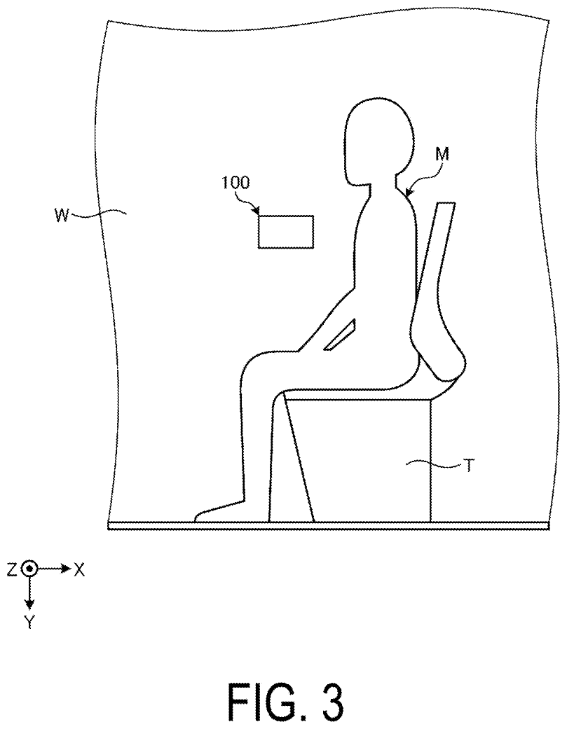

FIG. 3 is a view illustrating a placement example of an operation panel 100 in a toilet cubicle. The aerial display device 1 is disposed at the front surface of the operation panel 100. In FIG. 3, the operation panel 100 is provided at a position on a wall W. A user M sitting on a toilet seat T can easily reach the position. The height of the operation panel 100 from the floor surface is, for example, 1 m, and the horizontal position is equal to the position of the knees of the user M. Considering the average sitting height of Japanese people with respect to such a placement of the operation panel 100, the visual field range of the aerial display I in the vertical direction is, for example, 10 deg to 35 deg in the upward direction relative to the horizontal direction. The horizontal visual field range of the aerial display I is, for example, ±40 deg.

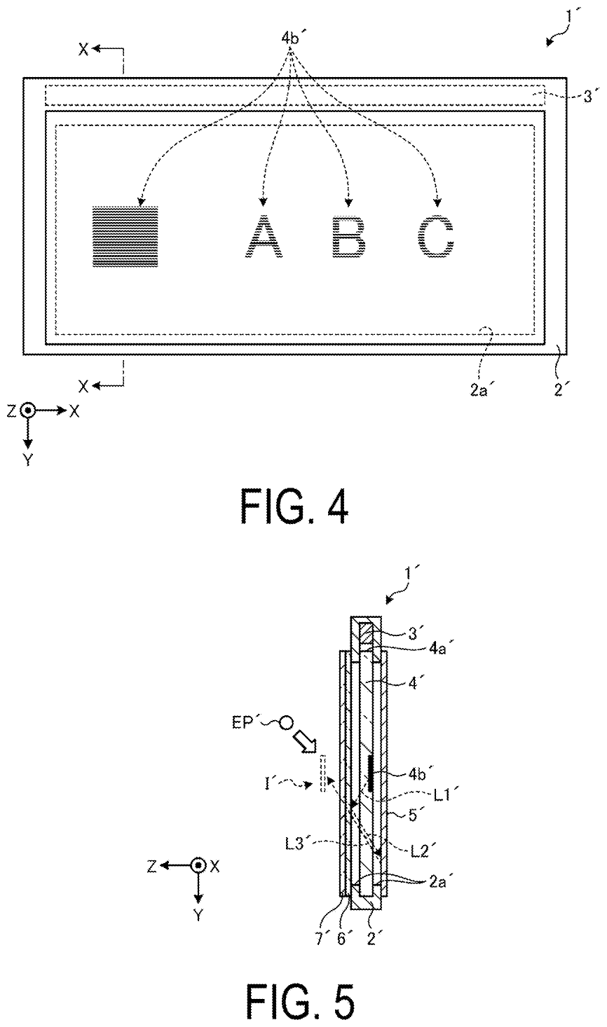

FIG. 4 is a view illustrating an example of an aerial display device 1′ as a comparative example, as viewed from the display surface side. FIG. 5 is a cross-sectional view taken along line X-X in FIG. 4. In FIGS. 4 and 5, in the aerial display device 1′, a linear light source 3′ and a light guide plate 4′ constituting a planar light-emitting body are disposed in a frame 2′, and a substantially rectangular opening 2a′ is formed in the frame 2′. The linear light source 3′ emits light linearly along the longitudinal direction of the light incident side surface 4a′ of the light guide plate 4′. The light guide plate 4′ is formed of a transparent material such as polycarbonate or acrylic, guides light incident from the light incident side surface 4a′ to the terminal end side, and reflects the light to the display surface side by a light-emitting portion 4b′ formed of an optical element provided at the back surface (non-display surface) side.

Further, a retroreflective sheet 5′ is disposed, at the non-display surface side of the frame 2′, covering the opening 2a′ with the reflective surface facing the light guide plate 4′. Further, a half mirror 6′ is disposed at the display surface side of the frame 2′, covering the opening 2a′, and a top cover 7′ is superimposed on the outside of the half mirror 6′.

In FIG. 5, about a half of light emitted, along a path L1′, from the light-emitting portion 4b′ of the light guide plate 4′ included in a transparent display device is reflected by the half mirror 6′, passes through the light guide plate 4′ along a path L2′, and impinges on the retroreflective sheet 5′. The light having impinged on the retroreflective sheet 5′ returns to the half mirror 6′ along a path L3′ at the emission angle being the same as the incident angle, and about a half of the light is transmitted. Since the light emitted from a certain point of the light-emitting portion 4b′ passes through the same position outside the aerial display device 1′ due to the geometric relationship even when the position of the path L1′ changes, aerial display I′ by the aerial image is performed outside the half mirror 6′ and the top cover 7′, and can be visually recognized from an eye point EP′ of the user.

Here, in the comparative example illustrated in FIGS. 4 and 5, there is a possibility that the quality of the aerial display is degraded due to the following reasons, for example:
the pattern boundary of the aerial display is unclear:
the light-emitting portion is visible; and
multiple images are visible.

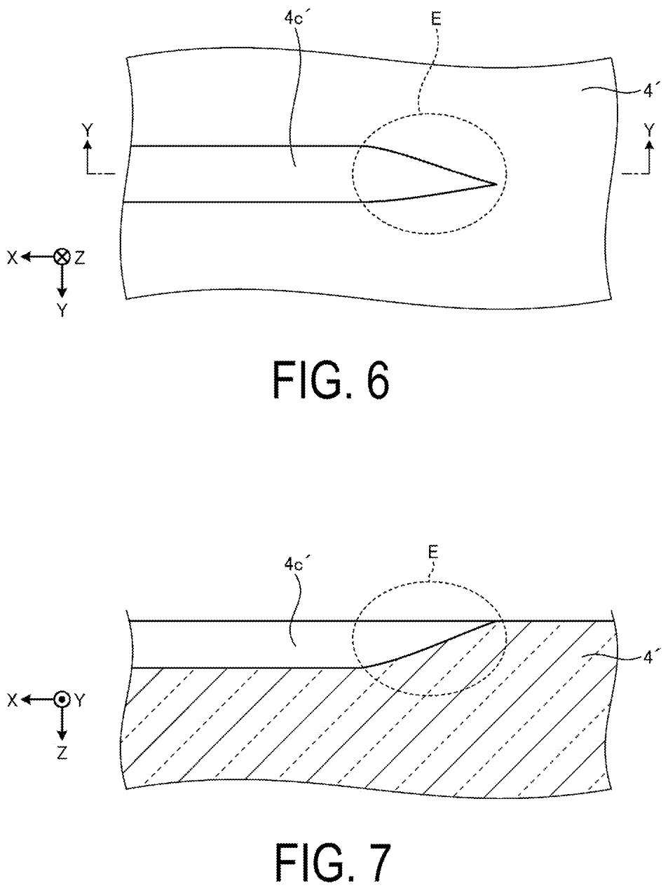

One of the causes of the above-described “the pattern boundary of the aerial display is unclear” is the processing method of the optical element 4c′ constituting the light-emitting portion 4b′ of the light guide plate 4′ (the same applies to the optical element 4c constituting the light-emitting portion 4b of the light guide plate 4 of the embodiment in FIGS. 1 and 2). FIG. 6 is a view of a part of the optical element 4c′ provided in the light guide plate 4′ as viewed from the normal direction of the back surface of the light guide plate 4′, and FIG. 7 is a cross-sectional view taken along line Y-Y in FIG. 6. In FIGS. 6 and 7, the optical element 4c′ is formed by cutting the light guide plate 4′ with a bite, a cutting tool, or the optical element 4c′ is formed in the process of forming the light guide plate 4′ with a mold provided with a protrusion corresponding to the optical element 4c′ with a bite. For this reason, the end portion E of the optical element 4c′ becomes narrow and shallow, the amount of light reflected toward the emission surface side decreases, and the pattern boundary of the aerial display becomes unclear.

In this respect, in the embodiment of FIGS. 1 and 2, the pattern boundary of the aerial display is determined by the through-holes 5a of the retroreflective sheet 5, and the end portion of the optical element 4c constituting the light-emitting portion 4b of the light guide plate 4 does not affect the pattern boundary of the aerial display, so that the pattern boundary of the aerial display can be made clear.

Another cause of “the pattern boundary of the aerial display is unclear” is that, in the comparative example of FIGS. 4 and 5, since the retroreflective sheet 5′ and the half mirror 6′ are provided with the light guide plate 4′ interposed between the retroreflective sheet 5′ and the half mirror 6′, the path of light is long and light passes through a large number of interfaces. That is, in FIG. 5, the light emitted from the light-emitting portion 4b′ travels along the path L1′, along the path L2′ along the path L3′, and passes through the front surface (a surface of the display surface side) of the light guide plate 4′, the back surface of the half mirror 6′, the front surface and back surface of the light guide plate 4′, the front surface (reflective surface) of the retroreflective sheet 5′, the back surface and front surface of the light guide plate 4′, the back surface and front surface of the half mirror 6′, and the back surface and front surface of the top cover 7′. When the path of light is long, diffusion of light is likely to occur, and when the number of interfaces is large, diffusion and attenuation of light are likely to occur due to fine uneven shapes of the interfaces, impurities inside the transparent resin, and the like. Thus, the pattern boundary of the aerial display becomes unclear.

In this respect, in the embodiment of FIGS. 1 and 2, the light emitted from the light-emitting portion 4b travels along the path L1, along the path L2, along the path L3, and passes through the front surface of the light guide plate 4, the back surface of the half mirror 6, the front surface (reflective surface) of the retroreflective sheet 5, the back surface and front surface of the half mirror 6, and the back surface and front surface of the top cover 7. Thus, the number of the interfaces to pass through and the length of passage in the transparent resin are reduced. As a result, the pattern boundary of the aerial display can be made clear.

Next, in the comparative example of FIGS. 4 and 5, the cause of the above-described “the light-emitting portion is visible” is that the light distribution from the light-emitting portion 4b′ of the light guide plate 4′ is not controlled, and the light travels directly from the light-emitting portion 4b′ to the eye point EP′. Although it is conceivable to perform light distribution control such that the light from the light-emitting portion 4b′ of the light guide plate 4′ does not directly travel toward the eye point EP′, it is difficult to completely eliminate the light traveling toward the eye point EP′. Therefore, even when the light distribution control is performed, some unnecessary light directly travels toward the eye point EP′.

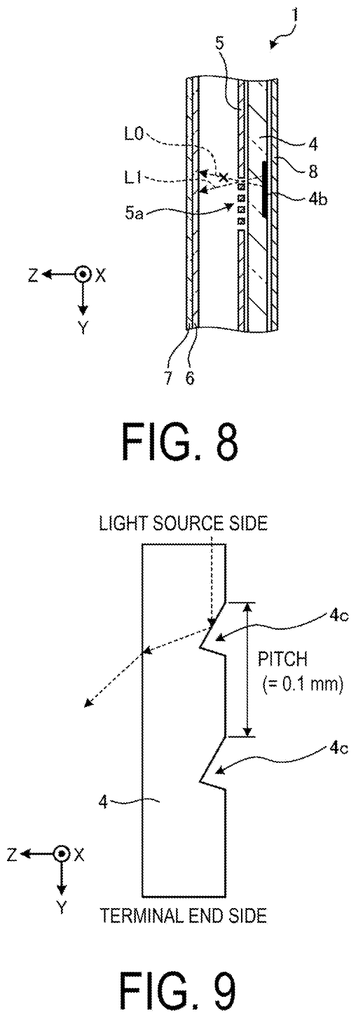

In this respect, in the embodiment illustrated in FIGS. 1 and 2, light is emitted in a direction such that the eye point EP at the display surface side does not exist in the direction (the lower left side in FIG. 2) by adjusting the optical element of the light-emitting portion 4b of the light guide plate 4, and therefore, the problem that the light-emitting portion is visible is solved. FIG. 8 is a view illustrating an example. In the example, the light-emitting portion 4b of the light guide plate 4 is in a state of being invisible by the light distribution control of the light-emitting portion 4b. In FIG. 8, the light emitted, along the path L0, from the light-emitting portion 4b of the light guide plate 4 is largely suppressed by the light distribution control, and the light of the normal path L1 becomes the main light, so that the light-emitting portion is not visible.

Hereinafter, the light distribution control of the light guide plate 4 will be described in more detail. FIG. 9 is a view illustrating an example of a shape of the optical element 4c constituting the light-emitting portion 4b of the light guide plate 4. Although a recessed optical element having a V-shaped cross-sectional shape is illustrated here, a recessed optical element having a polygonal cross-sectional shape or an optical element having a top-flat arc-shaped cross-sectional shape (an arc-shaped cross-sectional shape with a flat tip portion) may be used. In FIG. 9, the pitch of the arranged optical elements 4c is, for example, 0.1 mm, but the value of the pitch is not limited to this value.

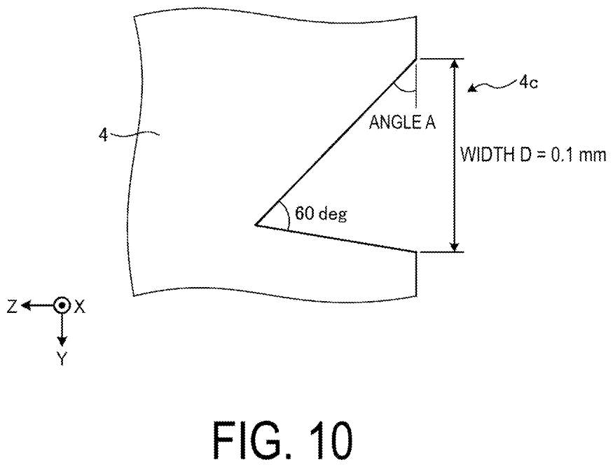

FIG. 10 is a view showing values defining a recessed optical element (FIG. 9) having a V-shaped cross-section as an example of the optical element 4c. In FIG. 10, the optical element 4c is defined by a width D, an apex angle, and a base angle (angle A) at the light rising side. Here, the width D is set to 0.1 mm, the apex angle is 60 deg, and the angle A is a variable. In a case where the light distribution control is performed in the above-described vertical visual field range of 10 deg to 35 deg, the width D=0.1 mm, the apex angle=60 deg, and the angle A=32 deg are suitable values from the result of the simulation. The horizontal visual field range ±40 deg is achieved by the light distribution in the horizontal direction by the linear light source 3. By the light distribution control, it is possible not only to prevent the light-emitting portion from being visible, but also to increase the light efficiency and improve the luminance by eliminating light emission in an unnecessary direction.

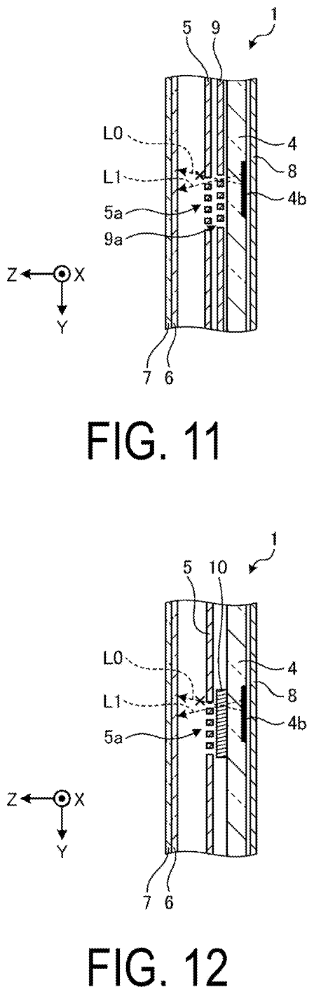

Although the light distribution control by a part of the optical element of the light guide plate 4 has been described with reference to FIGS. 8 to 10, another configuration for making the light-emitting portion 4b of the light guide plate 4 invisible will be described with reference to FIGS. 11 to 13. The suppression of the light emitted in a predetermined direction is mostly performed by the optical element 4c constituting the light-emitting portion 4b of the light guide plate 4 of the planar light-emitting body. In a case where the suppression is insufficient, the suppression is supplemented using the following optical members of FIGS. 11 to 13.

FIG. 11 is a view illustrating an example. In the example, the light-emitting portion 4b is in a state of being invisible by the light blocking sheet 9 provided with the through-holes 9a. FIG. 11 is different from FIG. 2 in that the light blocking sheet 9 is provided as a new optical member between the retroreflective sheet 5 and the light guide plate 4, and a plurality of through-holes 9a corresponding to the through-holes 5a of the retroreflective sheet 5 are shiftedly provided at the light blocking sheet 9. In FIG. 11, since the through-holes 9a of the light blocking sheet 9 are provided shifted to the upper side from the through-holes 5a of the retroreflective sheet 5, the light of the upward path L0 is suppressed, and the light of the downward path L1 becomes the main light.

FIG. 12 is a view illustrating an example. In the example, the light-emitting portion 4b is in a state of being invisible by a louver sheet 10. FIG. 12 is different from FIG. 2 in that the louver sheet 10 allowing passage of light in a predetermined direction (obliquely downward in the drawing) is provided as a new optical member between the retroreflective sheet 5 and the light guide plate 4. The light of the upward path L0 is suppressed by the louver sheet 10, and the light of the downward path L1 becomes the main light.

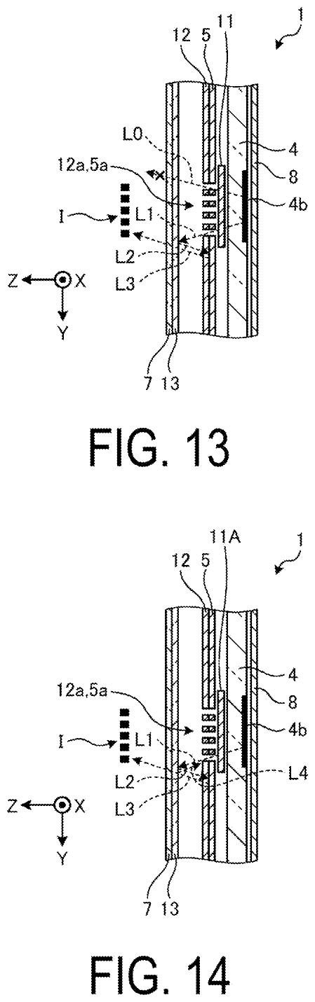

FIG. 13 is a view illustrating an example. In the example, the light-emitting portion 4b is in a state of being invisible by a polarizing reflection sheet 11, a retardation film 12, and a polarizing reflection sheet 13. FIG. 13 is different from FIG. 2 in that the polarizing reflection sheet 11, the retardation film 12, and the polarizing reflection sheet 13 are provided as new optical members. The polarizing reflection sheet 11 is disposed between the retroreflective sheet 5 and the light guide plate 4. The polarizing reflection sheet 11 may cover only the through-holes 5a of the retroreflective sheet 5, or may be layered at the entire surface. The retardation film 12 is disposed at the emission surface side of the retroreflective sheet 5, and through-holes 12a are provided at the same positions as the through-holes 5a of the retroreflective sheet 5. For example, after the retardation film 12 is attached to the retroreflective sheet 5, the through-holes 5a and the through-holes 12a are simultaneously formed. The phase difference of the retardation film 12 is λ/4, and the slow axis in the X-Y plane is inclined by 45° in the positive direction or the negative direction with respect to the polarization axis of the incident light (the polarization axis is the reflection axis or the transmission axis of the polarizing reflection sheet 13, and is consequently the X axis or the Y axis since the reflection axis and the transmission axis are basically disposed horizontally or vertically). The polarizing reflection sheet 13 is provided instead of the half mirror 6 (FIG. 2), and is disposed such that the transmission axis (the direction of the polarized light to be transmitted) is orthogonal to the transmission axis of the polarizing reflection sheet 11.

In FIG. 13, the light emitted, along the path L0, from the light-emitting portion 4b of the light guide plate 4 is polarized by the polarizing reflection sheet 11 to oscillate, for example, in the depth direction of the drawing, passes through the through-holes 5a of the retroreflective sheet 5 and the through-holes 12a of the retardation film 12, and reaches the polarizing reflection sheet 13. The state of polarized wave does not change in the through-holes 5a and 12a. Here, the light of the path L0 is suppressed since the polarizing reflection sheet 13 is disposed in an orientation such that, for example, the polarized wave oscillating in the up and down direction of the drawing passes the polarizing reflection sheet 13 in the orientation.

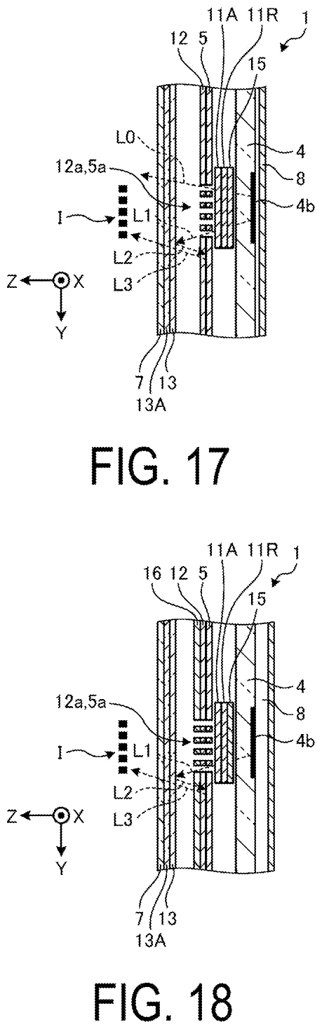

On the other hand, the light emitted, along the path L1, from the light-emitting portion 4b of the light guide plate 4 is polarized by the polarizing reflection sheet 11 to oscillate, for example, in the depth direction of the drawing, passes through the through-holes 5a of the retroreflective sheet 5 and the through-holes 12a of the retardation film 12, and reaches the polarizing reflection sheet 13. Here, since the polarizing reflection sheet 13 is disposed, for example, in an orientation such that a polarized wave oscillating in the up and down direction of the drawing passes through the polarizing reflection sheet 13 in the orientation, almost all of the polarized light is reflected to pass through the path L2, passes through the retardation film 12, is retroreflected by the retroreflective sheet 5, passes through the retardation film 12 again, and passes through the path U. Here, since the phase is shifted by λ/2 by two-time passage through the retardation film 12, the light is changed into a polarized wave oscillating in the up and down direction, passes through the polarizing reflection sheet 13, and becomes part of the aerial display I. Even a user wearing polarized sunglasses can visually recognize the aerial display I because the transmission axis of the polarized sunglasses is generally set in the up and down direction in the drawing. In the case where the transmission axis of the polarized sunglasses and the transmission axis of the aerial display I are orthogonal to each other, the aerial display I can be viewed by disposing a depolarizing sheet (for example, COSMOSHINE SRF manufactured by Toyobo Co., Ltd.) at the viewing side of the polarizing reflection sheet 13 (the same applies to the polarizing reflection sheet 13 in FIGS. 14 to 16 and an absorptive polarizing sheet 13A in FIG. 17 or 18 described below).

Next, the cause of the above-described “multiple images are visible” is that, in the comparative example of FIGS. 4 and 5, the interface is visible when the light passes through the light guide plate 4′ mainly along the paths L2′ and L3. In this respect, in the embodiment of FIGS. 1 and 2, the light emitted, along the path L1, from the through-holes 5a of the retroreflective sheet 5 does not pass through the interface of the light guide plate 4, so that the multiple images are not visible.

Next, FIGS. 14 to 18 illustrate improved examples of a configuration (polarizing configuration). In the configuration, the polarizing reflection sheets 11 and 13 and the retardation film 12 described with reference to FIG. 13 prevent the light directly emitted from the light-emitting portion 4b of the light guide plate 4 in the eye point direction through the through-holes 5a of the retroreflective sheet 5 from being visible. That is, in the configuration of FIG. 13, the return light (light traveling in the opposite direction of the path 1) obtained by the light of the polarized wave oscillating in the up and down direction of the path L3 in the drawing and reflected by the polarizing reflection sheet 13 passes through the through-holes 12a and 5a and impinges on the polarizing reflection sheet 11. The polarizing reflection sheet 13 basically reflects light of the polarized wave oscillating in the depth direction of the drawing, but also reflects a small amount of the light of the polarized wave oscillating in the up and down direction of the drawing. Since the degree of polarization of the polarizing reflection sheet is lower than the degree of polarization of the absorptive polarizing sheet, polarized light other than the polarized light in the transmission axis direction is transmitted and reflected. That is, when only the polarizing reflection sheet is used, the degree of polarization is low, and the transmission axis is shifted from the horizontal and vertical directions; therefore, the opening is visible. The transmission axis of the polarizing reflection sheet 13 is slightly shifted from the horizontal and vertical directions. Further, since the retardation film 12 does not have a retardation amount of λ/4 with respect to all wavelengths in the visible region, the light of the polarized wave in the path L3 does not completely oscillate in the up and down direction in the drawing. As described above, the polarizing reflection sheet 13 reflects not only the light of the polarized wave oscillating in the depth direction of the drawing but also the light of the polarized wave oscillating in the up and down direction in the light of the path L3. Since the polarizing reflection sheet 11 transmits the polarized wave in the depth direction of the drawing and reflects the polarized wave oscillating in the up and down direction of the drawing, the return light being the polarized wave oscillating in the up and down direction of the drawing is reflected, passes through the polarizing reflection sheet 13 at the outside as it is, and exits to the outside. Further, the light transmitted through the polarizing reflection sheet 11 is reflected by the planar light-emitting body (including a prism sheet in addition to the light guide plate 4 and the reflection sheet 8, in some cases), and part of the light transmitted through the polarizing reflection sheet 11 is transmitted through the polarizing reflection sheet 13. For this reason, the openings of the through-holes 12a and Sa appear to shine, and the visibility of the aerial display I decreases. FIG. 14 illustrates a countermeasure against this problem.

FIG. 14 is a cross-sectional view of an aerial display device illustrating a first improved example of the configuration of FIG. 13. The configuration of FIG. 14 is different from the configuration of FIG. 13 in that the polarizing reflection sheet (reflective polarizing sheet) 11 is replaced with an absorptive polarizing sheet 11A, and the direction of the polarized wave passing through the absorptive polarizing sheet 11A is the same as the direction of the polarized wave passing through the polarizing reflection sheet 11. The reflective polarizing sheet has a property of reflecting light of the polarized wave not transmitted, whereas the absorptive polarizing sheet has a property of absorbing light of the polarized wave not transmitted. It should be noted that the transmission axis of the absorptive polarizing sheet 11A is hardly shifted from the horizontal direction or the vertical direction of the sheets.

In FIG. 14, in the light emitted from the light-emitting portion 4b of the light guide plate 4 through the path L1, polarized components oscillating, for example, in the up and down direction of the drawing are absorbed by the absorptive polarizing sheet 11A, whereby a polarized wave oscillating in the depth direction of the drawing is obtained. The polarized wave passes through the through-holes Sa of the retroreflective sheet 5 and the through-holes 12a of the retardation film 12, and reaches the polarizing reflection sheet 13. Here, since the polarizing reflection sheet 13 is disposed, for example, in an orientation such that a polarized wave oscillating in the up and down direction of the drawing passes through the polarizing reflection sheet 13 in the orientation, almost all of the polarized light is reflected to pass through the path L2, passes through the retardation film 12, is retroreflected by the retroreflective sheet 5, passes through the retardation film 12 again, and passes through the path L3. Here, since the phase is shifted by λ/2 by two-time passage through the retardation film 12, the light is changed into a polarized wave oscillating in the up and down direction of the drawing, passes through the polarizing reflection sheet 13, and becomes part of the aerial display I.

Further, not all of the light of the path L3 passes through the polarizing reflection sheet 13, but part of the light is reflected by the polarizing reflection sheet 13, passes as return light through the through-holes 5a of the retroreflective sheet 5 and the through-holes 12a of the retardation film 12 along the path L4, and reaches the absorptive polarizing sheet 11A. The polarized wave of the return light oscillates in the up and down direction in the drawing. Here, since the absorptive polarizing sheet 11A transmits a polarized wave in the depth direction of the drawing and absorbs a polarized wave in the up and down direction of the drawing, most of the return light of the path L4 is absorbed. Therefore, the return light is not reflected by the absorptive polarizing sheet 11A, and the openings of the through-holes 12a and Sa do not appear to shine, so that the visibility of the aerial display I is not reduced.

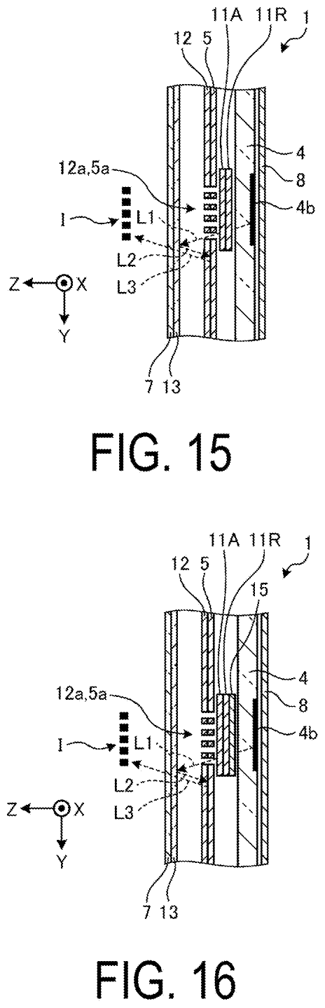

In the configuration of FIG. 14, the light emitted from the light-emitting portion 4b of the light guide plate 4 through the path L1 impinges on the absorptive polarizing sheet 11A, and the polarized wave oscillating in the depth direction of the drawing passes through the absorptive polarizing sheet 11A, but the polarized wave oscillating in the up and down direction of the drawing is absorbed, so that the loss of light is large, and finally the luminance of the aerial display I decreases. FIG. 15 illustrates a countermeasure against this problem.

FIG. 15 is a cross-sectional view of an aerial display device 1 illustrating a second improved example of the configuration of FIG. 13. The configuration of FIG. 15 is different from the configuration of FIG. 14 in that a reflective polarizing sheet 11R is provided between the absorptive polarizing sheet 11A and the light guide plate 4. The transmission axis of the reflective polarizing sheet 11R coincides or substantially coincides with the transmission axis of the absorptive polarizing sheet 11A. Note that the misalignment between the transmission axes of the absorptive polarizing sheet 11A and the reflective polarizing sheet 11R at the bottom (at the light guide plate 4 side) does not significantly affect the luminance and the opening visibility. The misalignment between the transmission axes of the absorptive polarizing sheet 13A and the polarizing reflection sheet 13 at the top (emission side) in FIG. 17 or 18 to be described below has a considerable influence on luminance and opening visibility. In addition, in FIG. 15, the absorptive polarizing sheet 11A and the reflective polarizing sheet 11R may be simply layered, but when the absorptive polarizing sheet 11A and the reflective polarizing sheet 11R are bonded to be in close contact with each other, interface reflection is reduced, contributing to improvement in luminance.

In FIG. 15, the light emitted from the light-emitting portion 4b of the light guide plate 4 through the path L1 impinges on the reflective polarizing sheet 11R before impinging on the absorptive polarizing sheet 11A, so that the polarized wave oscillating in the depth direction of the drawing is transmitted and the polarized wave oscillating in the up and down direction of the drawing is reflected. The light reflected by the reflective polarizing sheet 11R returns to the light guide plate 4 and is reused. The operation related to the absorptive polarizing sheet 11A and the following operation are the same as the operations in FIG. 14. Therefore, there is no loss of light due to the absorptive polarizing sheet 11A, and the luminance of the aerial display I is improved.

In the configuration of FIG. 15, when the light reflected by the reflective polarizing sheet 11R and returned to the light guide plate 4 (the polarized wave oscillating in the up and down direction in the drawing) is complexly reflected inside the light guide plate 4 or converted into a polarized wave oscillating in the depth direction in the drawing due to the phase difference of the optical component (the light guide plate 4, the prism sheet, for example) of the planar light-emitting body, the light passes through the reflective polarizing sheet 11R and can contribute to the luminance improvement of the aerial display I. However, when the direction of the polarized wave does not change inside the light guide plate 4, the contribution to the improvement of the luminance cannot be expected. FIG. 16 illustrates a countermeasure against this problem.

FIG. 16 is a cross-sectional view of an aerial display device 1 illustrating a third improved example of the configuration of FIG. 13. The configuration of FIG. 16 is different from the configuration of FIG. 15 in that a retardation film 15 is disposed between the reflective polarizing sheet 11R and the light guide plate 4. The phase difference of the retardation film 15 is λ/4, and the slow axis in the X-Y plane is inclined by 45° in the positive direction or the negative direction with respect to the polarization axis of the incident light (the polarization axis is the reflection axis or the transmission axis of the polarizing reflection sheet 13, and is consequently the X axis or the Y axis since the reflection axis and the transmission axis are basically disposed horizontally or vertically). The absorptive polarizing sheet 11A, the reflective polarizing sheet 11R, and the retardation film 15 may be simply layered, but when the absorptive polarizing sheet 11A, the reflective polarizing sheet 11R, and the retardation film 15 are bonded to be in close contact with each other, interface reflection is reduced, contributing to improvement in luminance.

In FIG. 16, light emitted from the light-emitting portion 4b of the light guide plate 4 through the path L1 passes through the retardation film 15. However, the light reflected by the reflective polarizing sheet 11R in the subsequent stage and returned to the light guide plate 4 (a polarized wave oscillating in the up and down direction in the drawing) passes through the retardation film 15, passes through the light guide plate 4, and passes through the retardation film 15 again, that is, passes through the retardation film 15 twice, and thus is converted into a polarized wave oscillating in the depth direction in the drawing. Therefore, the light can pass through the reflective polarizing sheet 11R, in the subsequent stage, and can contribute to the luminance improvement of the aerial display I. The subsequent operation is similar. Since the light emitted from the light guide plate 4 has a slight deviation in polarization, the light is slightly affected by the phase difference of the retardation film 15. Since the reflective polarizing sheet 11R is of a linearly polarizing type, the amount of transmitted light increases as the amount of polarized light of the transmission-axis components increases. Further, the retardation film 15 may be disposed at the light guide plate 4 side of the polarizing reflection sheet 11 in FIG. 13.

In the configurations of FIGS. 13 to 16, the polarized wave oscillating in the up and down direction of the drawing is transmitted by the polarizing reflection sheet 13 at the emission side, and the polarized wave oscillating in the depth direction of the drawing is reflected to the inside and blocked. In the polarizing reflection sheet 13 of a film-type, the transmission axis is slightly shifted from the horizontal and vertical axes of the sheet in many cases, and the polarized wave oscillating in the depth direction of the drawing is not completely blocked, causing the openings of the through-holes 12a and 5a to appear to shine. For example, part of the light of the path L0 in FIG. 13 is visible from the outside. FIG. 17 illustrates a countermeasure against this problem.

FIG. 17 is a cross-sectional view of an aerial display device 1 illustrating a fourth improved example of the configuration of FIG. 13. The configuration of FIG. 17 is different from the configuration of FIG. 16 in that the absorptive polarizing sheet 13A is disposed between the polarizing reflection sheet 13 and the top cover 7. The transmission axis of the absorptive polarizing sheet 13A is substantially the same as the transmission axis of the polarizing reflection sheet 13. When the transmission axes of the absorptive polarizing sheet 13A and the polarizing reflection sheet 13 are perfectly located, the effect is reduced. It is the most effective that the transmission axes coincide with each other and are orthogonal to the transmission axis of the absorptive polarizing sheet 11A. Therefore, when the angle between the transmission axes and the transmission axis of the absorptive polarizing sheet 11A is not 90°, the effect is reduced. Since the degree of polarization of the polarizing reflection sheet is lower than the degree of polarization of the absorptive polarizing sheet, the transmission and reflection of polarized light other than the polarized light in the transmission axis direction also cause the opening visibility. Therefore, when the transmission axes coincide with each other and are orthogonal to the transmission axis of the absorptive polarizing sheet 11A, the light is transmitted and reflected such that the loss is the smallest, so that the luminance is increased and the opening visibility can be reduced. Since the transmission axis of the polarizing reflection sheet 13 is slightly shifted from the vertical direction, if the transmission axis of the absorptive polarizing sheet 13A coincides with the shifted direction, this causes the opening visibility. To be exact, the transmission axes of the absorptive polarizing sheet 11A and the absorptive polarizing sheet 13A are orthogonal to each other. Further, although an example improved based on FIG. 16 is illustrated in FIG. 17, similar improvement may be made based on FIGS. 13 to 15.

In FIG. 17, most of the light of the path L0 of the polarized wave oscillating in the depth direction of the drawing is blocked by the polarizing reflection sheet 13, but when the transmission axis of the polarizing reflection sheet 13 is shifted in the X-Y plane, an amount of light corresponding to the shift passes without being blocked. However, since most of the polarized wave oscillating in the depth direction of the drawing is absorbed by the absorptive polarizing sheet 13A in the subsequent stage, there is almost no light emitted from the path L0 to the outside, the openings of the through-holes 12a and 5a are prevented from appearing to shine, and a decrease in the visibility of the aerial display I is prevented.

In the configurations of FIGS. 13 to 17, the retardation film 12 is provided at the emission side of the retroreflective sheet 5, and for example, the light of the path L2 of FIG. 17 passes through the retardation film 12 and is retroreflected by the retroreflective sheet 5 to become the light of the path L3. However, regular reflection also occurs at the front surface of the retardation film 12, causing an unnecessary aerial image. FIG. 18 illustrates a countermeasure against this problem.

FIG. 18 is a cross-sectional view of an aerial display device 1 illustrating a fifth improved example of the configuration of FIG. 13. The configuration of FIG. 18 is different from the configuration of FIG. 17 in that a low-reflection sheet 16 is provided at the emission side of the retardation film 12. The low-reflection sheet 16 is provided with through-holes 16a at the same positions as the through-holes 12a of the retardation film 12 and the through-holes 5a of the retroreflective sheet 5. For example, after the retardation film 12 and the low-reflection sheet 16 are bonded to the retroreflective sheet 5, the through-holes 5a, 12a, and 16a are simultaneously formed. Although an example improved based on FIG. 17 is illustrated in FIG. 18, similar improvement may be made based on FIGS. 13 to 16.

In FIG. 18, regular reflection of the light reflected along the path L2 from the polarizing reflection sheet 13 to the low-reflection sheet 16 is suppressed by the low-reflection sheet 16, and the light passes through the inside of the low-reflection sheet 16. Therefore, the generation of an unnecessary aerial image (an aerial image generated at a position twice as far as the distance between the aerial display I and the polarizing reflection sheet 13) based on regular reflection is prevented, and the deterioration of the visibility of the aerial display I is prevented. In addition, since the light used for the unnecessary aerial image is used for the aerial display I, the luminance of the aerial display I is improved.

The following Table 1 shows the calculation results of the luminance and contrast of the aerial display I and the like by the combination of sheets or films.

TABLE 1

| | Bottom | | | | Middle | | | | Top | | | Luminance [cd/m²] | | | | |
|---|---|---|---|---|---|---|---|---|---|---|---|---|---|---|---|---|
| | LV | λ/4 | rPol | aPol | Black | RR | λ/4 | AR | HM | rPol | aPol | A | B | C | CT1 | CT2 |
| FIG. 2 | — | — | — | — | ∘ | ∘ | — | — | ∘ | — | — | 542 | 500 | 24.8 | 1.08 | 21.8 |
| FIG. 12 | ∘ | — | — | — | ∘ | ∘ | — | — | ∘ | — | — | 396 | 28.5 | 20.9 | 13.9 | 19.0 |
| FIG. 13 | — | — | ∘ | — | ∘ | ∘ | ∘ | — | — | ∘ | — | 1082 | 222 | 87.7 | 4.88 | 12.3 |
| FIG. 14 | — | — | — | ∘ | ∘ | ∘ | ∘ | — | — | ∘ | — | 828 | 15.1 | 67.6 | 55.0 | 12.3 |
| FIG. 15 | — | — | ∘ | ∘ | ∘ | ∘ | ∘ | — | — | ∘ | — | 999 | 38.1 | 79.9 | 26.2 | 12.5 |
| FIG. 16 | — | ∘ | ∘ | ∘ | ∘ | ∘ | ∘ | — | — | ∘ | — | 1204 | 50.0 | 96.2 | 24.1 | 12.5 |
| Modification | — | — | ∘ | — | ∘ | ∘ | ∘ | — | — | ∘ | ∘ | 995 | 173 | 79.7 | 5.75 | 12.5 |
| Example #1 | | | | | | | | | | | | | | | | |
| Modification | — | — | — | ∘ | ∘ | ∘ | ∘ | — | — | ∘ | ∘ | 758 | 3.46 | 61.2 | 219 | 12.4 |
| Example #2 | | | | | | | | | | | | | | | | |
| Modification | — | — | ∘ | ∘ | ∘ | ∘ | ∘ | — | — | ∘ | ∘ | 916 | 4.82 | 72.6 | 190 | 12.6 |
| Example #3 | | | | | | | | | | | | | | | | |
| FIG. 17 | — | ∘ | ∘ | ∘ | ∘ | ∘ | ∘ | — | — | ∘ | ∘ | 1104 | 6.81 | 88.1 | 162 | 12.5 |
| FIG. 18 | — | ∘ | ∘ | ∘ | ∘ | ∘ | ∘ | ∘ | — | ∘ | ∘ | 1228 | 6.54 | 22.4 | 188 | 54.7 |

In Table 1, the leftmost column shows the figure number of the corresponding configuration. The Modification Examples #1 to #3 are not illustrated in the drawings. Note that Table 1 does not cover all combinations, and other configurations are also possible. In Table 1, “Bottom” is a sheet or film disposed between the light guide plate 4 and the retroreflective sheet 5, “Middle” is a sheet or film around the retroreflective sheet 5, and “Top” is a sheet or film around the top cover 7. “LV” is a louver sheet, “λ/4” is a retardation sheet, “rPol” is a reflective polarizing sheet, “aPol” is an absorptive polarizing sheet, “Black” is an absorbing sheet, “RR” is a retroreflective sheet, “AR” is a low-reflection sheet, “HM” is a half mirror, “A” is the luminance of a main aerial image, “B” is the luminance of an opening such as the through-holes Sa, “C” is the luminance of an unnecessary aerial image, “CT1” (contrast) is A/B, and “CT2” is A/C. The absorbing sheet “Black” in “Middle” is a reflective layer (5d) provided at the rear surface of the retroreflective sheet 5 described below.

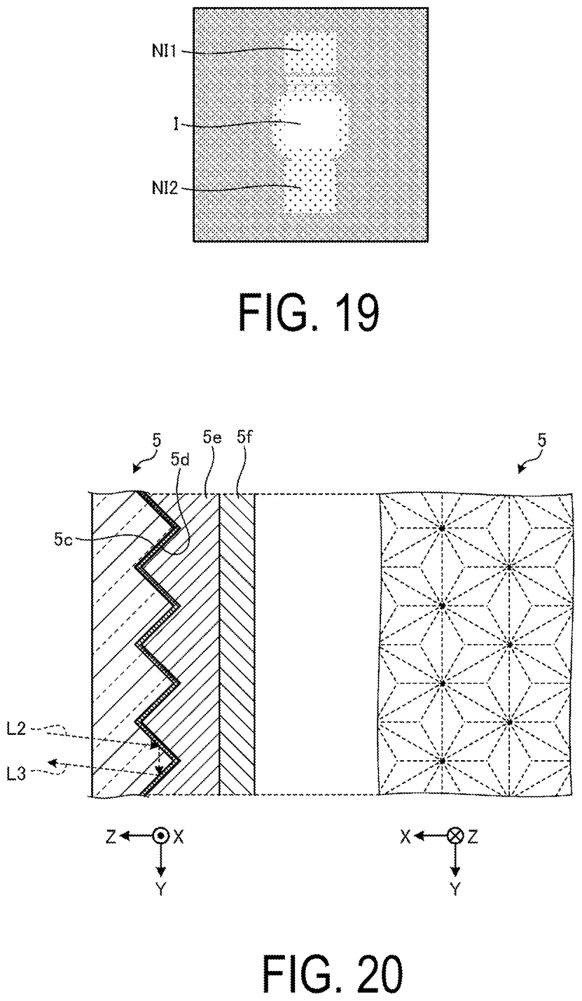

FIG. 19 is a view illustrating an example of the luminance distribution around the aerial display, and is a luminance distribution measured from a direction inclined by 23 degrees in the negative direction of the Y axis in FIG. 1 from the normal direction of the surface at the display side of the aerial display device 1 such that the center of the aerial display I is positioned at the center of the luminance meter. Due to the inclination by 23 degrees, the image NI1 of the openings by the through-holes 5a of the retroreflective sheet 5 or the like, the aerial display I, and the unnecessary image NI2 do not overlap with each other, and the luminance can be evaluated by the images separately. The unnecessary image NI2 is an aerial image generated at a position twice as far as the distance between the aerial display I and the polarizing reflection sheet 13. In FIG. 19, the central image is a main aerial image corresponding to the aerial display I, the upper image NI1 corresponds to the openings such as the through-holes 5a of the retroreflective sheet 5, and the lower image NI2 is an unnecessary aerial image due to front surface reflection or multiple reflection by the retroreflective sheet 5 or the like.

From Table 1, the configuration of FIG. 18 has the highest luminance “A” of the main aerial image, the configuration of Modification Example #2 has the highest contrast CT1, and the configuration of FIG. 18 has the highest contrast CT2.

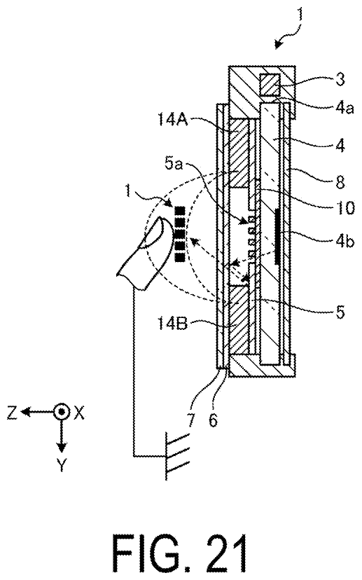

Next, a solution to the problem of the retroreflective sheet 5 in the configurations of FIGS. 1, 2, and 11 to 18 (the same applies to FIG. 21 described below) will be described. That is, since the retroreflective sheet 5 has some light transmittance, there is a problem in that the contrast of the aerial display I is reduced due to light leaking from a portion without the through-holes Sa. In the configuration of FIG. 11, since the light blocking sheet 9 is provided at the light-source side of the retroreflective sheet 5, the influence of the light leaking from the portion without the through-holes 5a is small, but it cannot be said that there is no influence, and thus the countermeasure is effective. In the case of the corner-cube type retroreflective sheet 5 provided with a reflective layer formed by metal vapor deposition or the like, such a problem of leakage light can be reduced by increasing the thickness of the reflective layer, but this leads to a significant increase in cost and is therefore not realistic.

FIG. 20 is a cross-sectional view illustrating an example of a structure of the retroreflective sheet 5. In FIG. 20, in the retroreflective sheet 5, prisms 5c each constituting a corner cube and having an apex angle of 90° are formed at the back side of a transparent plate, and a reflective surface is formed, at the outside of the prisms, using a reflective layer 5d formed by metallic vapor deposition or the like. As is clear from the plan view on the right side, at the surface with the reflective layer 5d being formed, triangular pyramid-shaped prisms are arranged vertically and horizontally. In addition, for example, a black light blocking sheet 5f is attached to the rear surface of the reflective layer 5d via an adhesive 5e. When the adhesive Se is black or the like and has low transmittance, the light blocking sheet 5f need not be black or the like. Further, in order to improve the contrast, a diffusion sheet having scattering characteristics equivalent to the scattering characteristics of the light blocking sheet may be disposed as the light blocking sheet 5f. When the retroreflective sheet 5 having such a structure is used in the configurations of FIGS. 1, 2, and 11 to 18 (the same applies to FIG. 21 to be described below), light leaking from a portion of the retroreflective sheet 5 without the through-holes 5a is reduced, and a decrease in the contrast of the aerial display I is prevented.

In addition, it has been confirmed that the light blocking sheet 5f at the rear surface of the retroreflective sheet 5 in FIG. 20 not only has a high light blocking property, but also affects the contrast of the aerial display I, depending on the scattering state of the front surface at the light guide plate 4 side. Table 2 shows “Aerial image evaluation” and “Black film evaluation” for the light blocking sheet (black film) 5f identified by “Manufacturer” and “Trade name”. “PMMA” immediately below “Manufacturer” and “Trade name” means acrylic resin, and corresponds to a state without the light blocking sheet. The “Aerial image evaluation” includes the luminance “A I” of the main aerial image, the luminance “Opening” of the opening, the contrast “CT”, and the “Leakage light”. “AI” corresponds to “A” in Table 1, “Opening” corresponds to “B” in Table 1, and “CT” corresponds to “CT1” in Table 1. The “Black film evaluation” includes “Total light transmission”, “Total reflection”, “Regular reflection”, and “Glossiness”. Table 3 includes “Total thickness”, “Substrate”, “Front surface”, and “Coating treatment” for the light blocking sheet (black film) 5f identified by “Manufacturer” and “Trade name”. “AG” in “Front surface” means antiglare treatment.

TABLE 2

| | | Aerial image evaluation | | | | Black film evaluation | | | |
|---|---|---|---|---|---|---|---|---|---|
| | | Luminance | | | | Total | Total | Regular | |
| | Trade | [cd/m²] | | | Leakage | light | reflection | reflection | Glossiness |
| Manufacturer | name | AI | Opening | CT | light | transmission | (8 deg) | (5 deg) | (60 deg) |
| PMMA | | 119 | 6.38 | 18.7 | 1.8 | 92% | 4.0% | 4.0% | — |
| Toray | X30 #25 | 121 | 6.63 | 18.3 | 0.6 | 9.4% | 7.4% | 5.2% | — |
| | X30 #50 | 121 | 6.41 | 18.8 | 0.5 | 0.95% | 7.2% | 5.5% | — |
| | X30 #75 | 121 | 6.54 | 18.5 | 0.5 | 0.085% | 7.2% | 5.6% | — |
| Kimoto | X1B22 #12 | 120 | 6.77 | 17.8 | 0.6 | 0.005% | 4.9% | 0.048% | 3.0% |
| | X1B #38 | 120 | 6.73 | 17.9 | 0.4 | — | 4.9% | 0.053% | 3.0% |
| | X1B #188 | 121 | 6.67 | 18.1 | 0.5 | — | 4.9% | 0.050% | 3.0% |
| | X2B #50 | 123 | 5.93 | 20.7 | 0.5 | — | 4.9% | 0.042% | 2.0% |
| | X2B #75 | 121 | 5.86 | 20.6 | 0.5 | — | 4.9% | 0.043% | 2.0% |
| | X4LGB #25 | 122 | 5.88 | 20.8 | 0.6 | — | 3.4% | 0.021% | 0.7% |
| | X30B #50 | 121 | 6.73 | 18.0 | 0.5 | 0.53% | 7.3% | 0.136% | |
| | X30B #100 | 121 | 6.79 | 17.9 | 0.5 | 0.006% | 7.4% | 0.103% | |
| | X30B #188 | 120 | 6.72 | 17.8 | 0.6 | — | 7.3% | 0.083% | |

TABLE 3

| | | Total | | | |
|---|---|---|---|---|---|
| | | thickness | | Front | Coating |
| Manufacturer | Trade name | [μm] | Substrate | surface | treatment |
| Toray | X30 #25 | 24 | Black | None | No |
| | X30 #50 | 50 | Black | None | No |
| | X30 #75 | 76 | Black | None | No |
| Kimoto | X1B22 #12 | 21 | Transparent | AG | Yes |
| | X1B #38 | 55 | Black | AG | Yes |
| | X1B #188 | 205 | Black | AG | Yes |
| | X2B #50 | 78 | Black | AG | Yes |
| | X2B #75 | 104 | Black | AG | Yes |
| | X4LGB #25 | 36 | Black | AG | Yes |
| | X30B #50 | 52 | Black | AG | No |
| | X30B #100 | 104 | Black | AG | No |
| | X30B #188 | 194 | Black | AG | No |

As can be seen from Tables 2 and 3, the “Leakage light” is significantly reduced with any of the light blocking sheets as compared with the “Leakage light” in the case of “PM MA”, the state without a light blocking sheet. The contrast “CT” is excellent in “X2B #50”, “X2B #75”, and “X4LGB 425”. That is, when the antiglare treatment is performed and the “Regular reflection” is smaller, the contrast “CT” is more improved. This is presumably because when the scattering of the light scattered and reflected by the light blocking sheet is weak and the regular reflection is strong, the light is emitted from the opening and the luminance of the opening is increased. For example, in FIG. 2, the light emitted from the light guide plate 4 is reflected by the light blocking sheet at the light guide plate 4 side of the retroreflective sheet 5, and there are components reflected by the front surface of the light guide plate 4 and emitted to the eye point EP side through the openings of the through-holes 5a. However, when the regular reflection of the light blocking sheet is small, the noise components are reduced, and the luminance of the openings becomes low.

Next, a configuration for causing the aerial display to operate as a button of anon-contact type electrical switch will be described. FIG. 21 is a view illustrating an example of detection of a touch on the aerial display I by an electrostatic sensor including sensor electrodes 14A and 14B. FIG. 21 is different from FIG. 2 in that a pair of sensor electrodes 14A and 14B is provided outside the through-holes 5a at the emission surface side of the retroreflective sheet 5. When a voltage is applied between the sensor electrodes 14A and 14B, electric lines of force indicated by broken lines are generated. In a process of the user's touching the aerial display I with the finger F, the finger F at the ground level causes a change in the electric lines of force, and the touch on the aerial display I can be detected from the change. Since the user's finger F only touches the aerial display I and does not touch an actual button or the like, it is desirable in terms of hygiene. The contact of the finger F with the aerial display I may be detected by an infrared (IR) sensor or the like, and the corresponding function may be controlled to be turned on or off, for example.

As the retroreflective sheet 5, for example, a prism-type retroreflective sheet is used. In this case, AI is vapor-deposited at the prism surface of the retroreflective sheet 5, and thus light hardly passes through a place other than the through-holes 5a. In addition, since the metal blocks the electric lines of force, the electrostatic sensor needs to be disposed at the emission surface side of the retroreflective sheet 5. Since the imaging distance of the aerial image depends on the distance between the half mirror 6 and the retroreflective sheet 5, the distance between the half mirror 6 and the retroreflective sheet 5 increases when the aerial image is to be formed at a position away from the top cover 7. Therefore, the dead space can be utilized by disposing the sensor electrodes 14A and 14B and a control board in the gap. The sensor electrodes 14A and 14B and the control board are disposed so as not to obstruct the optical path. In addition, it is preferable that the control board is black or black-printed so that stray light is not irregularly reflected. When the color is black, the sensor electrodes 14A and 14B and the control board are difficult to see from the viewing side. Further, FIG. 21 is based on the configuration of FIG. 2, but may be based on the configurations of FIGS. 11 to 18.

The embodiment of the present invention has been described above, but the present invention is not limited to the embodiment described above, and various modifications are possible without departing from the spirit of the present invention.

As described above, the aerial display device according to the embodiment includes a planar light-emitting body including a light-emitting portion; a retroreflective sheet disposed at an emission surface side of the planar light-emitting body and including, at a position corresponding to the light-emitting portion, a plurality of through-holes representing a figure to be displayed in the air; and a half mirror disposed at an emission surface side of the retroreflective sheet. Thus, the quality of the aerial display can be improved.

Further, light distribution of the planar light-emitting body is controlled in a predetermined direction. Thus, light distribution control can be performed by the planar light-emitting body alone, and the problem of the light-emitting portion being visible can be solved.

Further, the planar light-emitting body includes a linear light source and a light guide plate, and the light-emitting portion is composed of an optical element. Thus, the planar light-emitting body can be easily obtained.

Further, an optical member is provided. The optical member suppresses light emitted from the through-holes of the retroreflective sheet in a direction, an eye point existing in the direction. Thus, it is possible to more effectively solve the problem that the light-emitting portion is visible.

Further, the optical member is a light blocking sheet disposed between the retroreflective sheet and the planar light-emitting body and including a plurality of through-holes shiftedly provided corresponding to the through-holes of the retroreflective sheet. Thus, the light distribution control by the planar light-emitting body can be supplemented, and the problem that the light-emitting portion is visible can be more effectively solved.

Further, the optical member is a louver sheet disposed between the retroreflective sheet and the planar light-emitting body. The louver sheet allows passage of light in a predetermined direction. Thus, the light distribution control by the planar light-emitting body can be supplemented, and the problem that the light-emitting portion is visible can be more effectively solved.

Further, the optical member includes a first reflective polarizing sheet disposed between the retroreflective sheet and the planar light-emitting body; a first retardation film disposed at an emission surface side of the retroreflective sheet and including through-holes provided at the same positions as the through-holes of the retroreflective sheet; and a second reflective polarizing sheet provided instead of the half mirror. Thus, the light distribution control by the planar light-emitting body can be supplemented, and the problem that the light-emitting portion is visible can be more effectively solved.

Further, an absorptive polarizing sheet is provided instead of the first reflective polarizing sheet. This prevents the openings of the through-holes from appearing to shine due to the light reflected by the first polarizing reflection sheet through the through-holes of the retroreflective sheet, thereby preventing a decrease in the visibility of the aerial display.

Further, a reflective polarizing sheet disposed between the absorptive polarizing sheet and the planar light-emitting body is provided. Thus, the loss of light due to the absorptive polarizing sheet is reduced, and the luminance of the aerial display is improved.

Further, a second retardation film disposed between the planar light-emitting body and the reflective polarizing sheet adjacent to an emission surface side of the planar light-emitting body is provided. Thus, the reuse of the light returned to the planar light-emitting body side by the reflective polarizing sheet is promoted, and the luminance of the aerial display is improved.

Further, another absorptive polarizing sheet is provided at an emission surface side of the second reflective polarizing sheet. Thus, the transmission of the unnecessary polarization component due to the misalignment of the transmission axis of the second polarizing reflection sheet is prevented, and the visibility of the aerial display is improved.

Further, a low-reflection sheet is provided at an emission surface side of the first retardation film. Thus, an unnecessary aerial image due to reflection at the front surface of the first retardation film is suppressed, the visibility of aerial display is improved, and the luminance of the aerial display is also improved.

Further, a light blocking sheet is provided at the planar light-emitting body side of the retroreflective sheet. Thus, the leakage light from the portion without the through-holes is reduced, and the contrast is improved.

Further, a front surface of the light blocking sheet at the planar light-emitting body side is subjected to antiglare treatment for reducing regular reflection. Thus, the openings of the through-holes are inhibited from appearing to shine due to reflection at the surface of the retroreflective sheet at the planar light-emitting body side, and the contrast is improved.

Further, the light-emitting portion of the planar light-emitting body emits light in a substantially rectangular region covering positions of through-holes likely to be used to represent the figure to be displayed in the air, or emits light in a region covering positions corresponding to the through-holes of the retroreflective sheet. Thus, it is possible to provide options for the configuration of the light-emitting portion.

Further, a reflection sheet disposed at a side opposite to an emission surface of the planar light-emitting body is provided. Thus, light leakage can be reduced, light efficiency can be increased, and luminance can be increased.

Further, a pair of sensor electrodes constituting an electrostatic sensor is provided at a portion outside the through-holes at the emission surface side of the retroreflective sheet. Thus, a non-contact type switch suitable for aerial display can be configured.

Moreover, the present invention is not limited to the embodiments described above. A configuration obtained by appropriately combining the above-mentioned constituent elements is also included in the present invention. Further effects and modified examples can be easily derived by a person skilled in the art. Thus, a wide range of aspects of the present invention are not limited to the embodiments described above and may be modified variously.

### REFERENCE SIGNS LIST

1 Aerial display device, 2 Frame, 2a Opening, 3 Linear light source, 4 Light guide plate, 4a Light incident side surface, 4b Light-emitting portion, 5 Retroreflective sheet, 5a Through-hole, 6 Half mirror, 7 Top cover, 8 Reflection sheet, 9 Light blocking sheet, 9a Through-hole, 10 Louver sheet, 11 Polarizing reflection sheet, 11A Absorptive polarizing sheet, 11R Reflective polarizing sheet, 12 Retardation film, 13 Polarizing reflection sheet, 13A Absorptive polarizing sheet, 14A, 14B Sensor electrode, EP Eye point, I Aerial display, F Finger

1. An aerial display device comprising:
a planar light-emitting body including a light-emitting portion;
a retroreflective sheet disposed at an emission surface side of the planar light-emitting body and including, at a position corresponding to the light-emitting portion, a plurality of through-holes representing a figure to be displayed in the air; and
a half mirror disposed at an emission surface side of the retroreflective sheet.

2. The aerial display device according to claim 1, wherein
light distribution of the planar light-emitting body is controlled in a predetermined direction.

3. The aerial display device according to claim 1, wherein
the planar light-emitting body includes a linear light source and a light guide plate, and
the light-emitting portion is composed of an optical element.

4. The aerial display device according to claim 1, comprising an optical member configured to suppress light emitted from the through-holes of the retroreflective sheet in a direction, an eye point existing in the direction.

5. The aerial display device according to claim 4, wherein
the optical member is a light blocking sheet disposed between the retroreflective sheet and the planar light-emitting body and including a plurality of through-holes shiftedly provided corresponding to the through-holes of the retroreflective sheet.

6. The aerial display device according to claim 4, wherein
the optical member is a louver sheet disposed between the retroreflective sheet and the planar light-emitting body and allowing passage of light in a predetermined direction.

7. The aerial display device according to claim 4, wherein
the optical member includes
a first reflective polarizing sheet disposed between the retroreflective sheet and the planar light-emitting body;
a first retardation film disposed at an emission surface side of the retroreflective sheet and including through-holes provided at the same positions as the through-holes of the retroreflective sheet; and
a second reflective polarizing sheet provided instead of the half mirror.

8. The aerial display device according to claim 7, comprising an absorptive polarizing sheet provided instead of the first reflective polarizing sheet.

9. The aerial display device according to claim 8, comprising a third reflective polarizing sheet disposed between the absorptive polarizing sheet and the planar light-emitting body.

10. The aerial display device according to claim 7, comprising a second retardation film disposed between the planar light-emitting body and the reflective polarizing sheet adjacent to an emission surface side of the planar light-emitting body.

11. The aerial display device according to claim 7, comprising another absorptive polarizing sheet provided at an emission surface side of the second reflective polarizing sheet.

12. The aerial display device according to claim 7, comprising a low-reflection sheet provided at an emission surface side of the first retardation film.

13. The aerial display device according to claim 1, comprising a light blocking sheet provided at a side of the planar light-emitting body of the retroreflective sheet.

14. The aerial display device according to claim 13, wherein a front surface of the light blocking sheet at the side of the planar light-emitting body is subjected to antiglare treatment for reducing regular reflection.

15. The aerial display device according to claim 1, wherein
the light-emitting portion of the planar light-emitting body is configured to emit light in a substantially rectangular region covering positions of through-holes likely to be used to represent the figure to be displayed in the air, or to emit light in a region covering positions corresponding to the through-holes of the retroreflective sheet.

16. The aerial display device according to claim 1, comprising a reflection sheet disposed at a side opposite to an emission surface of the planar light-emitting body.

17. The aerial display device according to claim 1, wherein
a pair of sensor electrodes constituting an electrostatic sensor is provided at a portion outside the through-holes at the emission surface side of the retroreflective sheet.
